(19) United States
(12) Patent Application Publication
(10) Pub. No.: US 2006/0181730 A1
(43) Pub. Date: Aug. 17, 2006

(54) System and method for controlling a printing device with a portable computing device

(76) Inventor: Keith E. Moore, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/057,955

(22) Filed: Feb. 15, 2005

(51) Int. Cl. G06F 3/12

(52) U.S. Cl. 358/1.15

(57) ABSTRACT

A system for enhancing functionality of printing device is disclosed. The system comprises a non-portable computing device and a printing device connected to the non-portable computing device. The system also comprises a portable computing device intermediate the non-portable device and the printing device. A communication path is established between the portable computing device and the printing device with the portable computing device assuming control of operation of the printing device.

### BACKGROUND

Portable or mobile computing devices are well known. These devices may be handheld and are also referred to as personal digital assistants (PDAs). PDAs provide users with mobility and portability of information. While these devices are primarily used for storing contact and scheduling information, they can also be used for communications such as sending and receiving electronic mail as well as for making and receiving phone calls using cellular technology.

What would be desirable is to utilize the mobility and portability of information of a portable device, such as a PDA, for controlling and enhancing the functionality of printing devices.

### SUMMARY

In one aspect, a system is disclosed. The system comprises a non-portable computing device and a printing device connected to the non-portable computing device. The system also comprises a portable computing device intermediate the non-portable device and the printing device. A communication path is established between the portable computing device and the printing device with the portable computing device assuming control of operation of the printing device.

### BRIEF DESCRIPTION OF THE DRAWINGS

The accompanying drawings, which are incorporated in and constitute a part of the specification, illustrate an embodiment of the invention and, together with the description, explain the invention. In the drawings,

FIG. 1 illustrates an exemplary portable computing device;

FIG. 2 illustrates an exemplary printing device;

FIGS. 3A-3B illustrate embodiments of connections between a non-portable computing device, a portable computing device and a printing device;

FIG. 4 illustrates a method in accordance with exemplary embodiments;

FIG. 5 illustrates a method in accordance with exemplary embodiments utilizing a sequence diagram;

FIG. 6 illustrates a method in accordance with some embodiments of a non-portable computing device controlling a printing device; and

FIGS. 7A and 7B illustrate a print queue status window.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

In general, the present invention is a system and method for controlling a printing device using a portable computing device. Specifically, a personal digital assistant (PDA) may be docked with a printer to control the functionality of the printer in exemplary embodiments. In other embodiments, the functionality of a printer may also be augmented or enhanced by a PDA.

A printing device may include, but is not limited to, a multi-function peripheral (MFP) or an All-In-One (AIO) device which incorporates several functions into one device, or a single function printer. The printing device may use inkjet or laser technology. The functionality of the MFP or AIO may include that of one or more of a printer, a copier, a scanner, a facsimile machine, a digital sender (i.e. sending a message to an e-mail address) and a telephone for example. Each or these terms (i.e. printer, AIO and MFP) may be used interchangeably for the purposes of this invention.

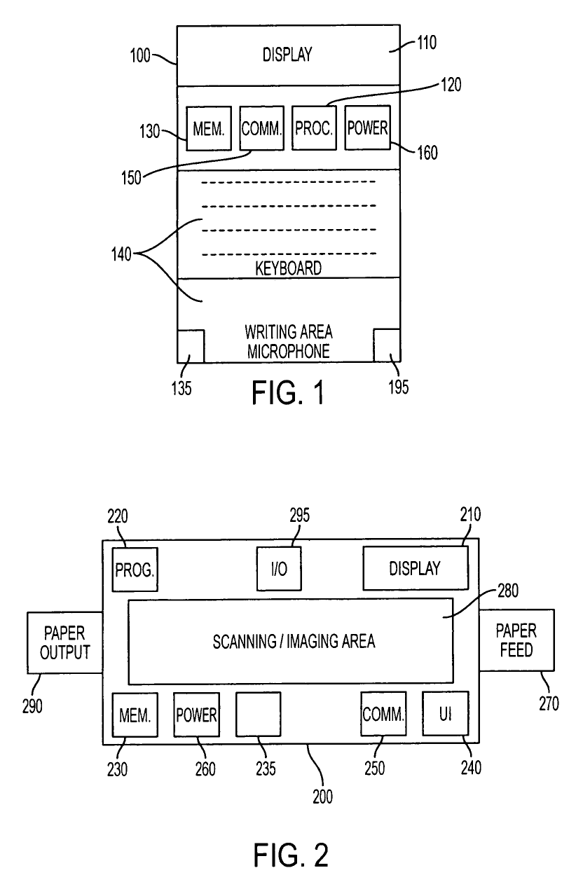

A portable device may comprise, but is not limited to, a cell phone, PDA, or any other portable device having computing capability. FIG. 1 shows an exemplary portable computing device, PDA 100, including a display 110, a processor 120, a memory 130, a media reader 135, an user interface 140, a communication component 150, a power supply 160 and I/O ports 195.

I/O ports 195, such as a USB port, may facilitate connection of the PDA to a computer or to a printer for example. The power supply 160 may be a disposable or a rechargeable battery; it may also be a connection to an electrical outlet.

Communication component 150 may include a modem that can be physically connected to a telephone line or to a high speed network; it may be a wireless connection such as Bluetooth. Communication component 150 may also include a cellular telephone.

The user interface 140 may include a physical or a touch-sensitive keyboard, a writing area using an electronic stylus and/or a microphone. A handwriting recognition feature may facilitate the electronic stylus and a voice recognition feature may facilitate the microphone.

Media reader 135 may house a memory stick, a flash card or similar storage medium for example. The memory stick may function as additional memory for storing data from the PDA for example.

An exemplary printing device, device 200, is illustrated in FIG. 2 and comprises, but is not limited to, a display 210, a processor 220, a memory 230, a media reader 235, a user interface 240, a communication component 250, a power supply 260, a paper input area 270, a scanning/imaging area 280, a paper output area 290 and one or more I/O ports 295.

The input/output ports 295 may include a parallel port or a USB port for example; these ports may facilitate connection of device 200 to a computer, to a computer network or to a digital camera for example. The paper input area 270 may be one or more paper cassettes for example.

Communication component 250 may include a modem that can be physically connected to a telephone line or can also communicate via a wireless medium. Communication component 250 may also facilitate facsimile functionality or a digital send functionality of sending a message or a document to an e-mail address.

The user interface 240 may include a keyboard or function keys for specifying paper source, contrast of an image to be copied or scanned, number of copies to be made if using the copying function (or printing digital images) for example. User interface 240 may also be used to dial or enter a telephone number if the fax functionality of the printer is being used. An e-mail address may also be entered via the user interface.

The display 210 may reflect the status of selections made via user interface 240; it may also display preview of documents or images that are to be reproduced (or printed) for example.

Media reader 235 may include one or more slots for housing a memory stick, a flash card, etc. Once inserted into the slot, contents of the memory stick or flash card may be accessed by device 200 and displayed on display 210. Certain types of media may also be connected directly to the I/O ports 295 and contents accessed by the device 200 and displayed on display 210.

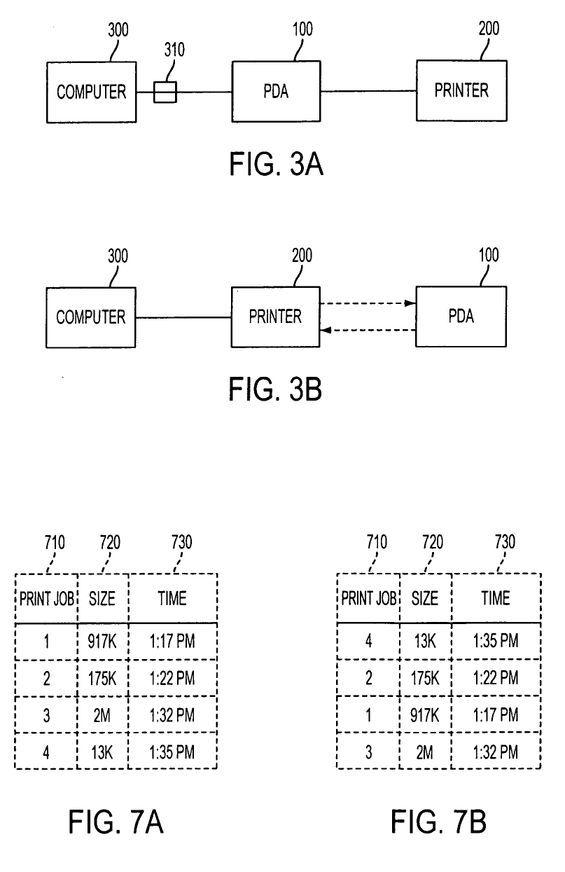

The portable computing device (e.g., PDA 100) may augment (or enhance) the functionality of a printing device (e.g., printer 200) in exemplary embodiments. Referring to FIG. 3A, PDA 100 may be inserted into the print pipeline between a non-portable computing device (e.g., computer 300) and printer 200 as illustrated in FIG. 3A. The non-portable computing device may be on a network and may comprise a desktop computer.

It should be noted that for purposes of this disclosure the term “non-portable” refers to something that is physically difficult to transport from its present location to a new location. For instance, most desktop computers are connected to cables and are physically heavy, making them cumbersome to disconnect and move. In an alternative embodiment, the non-portable computing device may be embodied as a docked laptop computer. Specifically, although a laptop computer on its own is portable, a laptop computer that is in a docking station may have many connections to connect it to other peripheral devices (e.g., a display, a key board, etc.) thereby making the docked laptop computer a non-portable computing device for purposes of the present invention.

Print jobs over a network or from a computer may be processed via a print spooler 310 prior to reaching PDA 100. The printer functionality may be controlled by PDA 100. PDA 100 may function as a user interface to printer 200 upon insertion in the print pipeline. As a result, user interface 240 of printer 200 may be disabled in some embodiments. In other embodiments, the PDA may function as a second user interface (i.e. in addition to the user interface of the printer).

As illustrated in FIG. 3A, PDA 100 may be inserted between computer 300 and printer 200. PDA 100 may be co-located with or in close proximity to printer 200. Print jobs from computer 300 may be routed through PDA 100 to printer 200. In some embodiments, PDA 100 may be connected to printer 200, or “piggy backed” onto the printer as illustrated in FIG. 3B. In another embodiment as illustrated in FIG. 3B, PDA 100 may be located beyond printer 200 (i.e. downstream from printer 200) in a computer network. Print jobs from computer 300 to printer 200 may be re-routed through PDA 100 (i.e. from printer 200 to PDA 100 and back to printer 200). In other words, no processing may take place in printer 200 until the jobs or documents are processed by PDA 100. Printer 200 may be one of a plurality of terminal points.

The portable computing device may be connected or docked to the printing device via USB ports (e.g., USB port 195 of PDA 100 and USB port 295 of printer 200) to establish a physical connection or via a wireless interface. In the wireless case, a wireless broadcast or a message may be transmitted by one of the two devices (i.e. PDA or printer). The message may contain the address information of the broadcasting device. When the other device (receiving device) receives the message, it issues a “bind” message to the sender using the address information. In this manner, the wireless beacon can be used in much the same way as a hardware connection. In both cases, a probe is used to discover the other party. Upon docking, an initialization procedure may take place between the portable computing device and the printing device for authentication purposes.

In an exemplary embodiment, the printing device may be designed using a distributed object infrastructure. Exemplary distributed object infrastructures include the Object Management Group's CORBA infrastructure and Microsoft® Component Object Model. A remote procedure call mechanism that supports callbacks may be used. The distributed object infrastructure supports a set of distributable objects. The distributable objects may form the firmware for the printing device. Among the distributable objects may be the user interface (UI), menu management control (MMC) and job management (JM) attributes. These objects may be connected to each other via the distributed object infrastructure and the remaining firmware of the printing device can interact with these (for example, UI, MMC and JM) objects by issuing object invocations.

When the printing device is powered on, firmware may be loaded and connected such that the parts of the print system (associated with printing functionality) can interact with the user interface or job manager objects. These objects (i.e. user interface and/or job manager) in turn send messages back to the rest of the print system. As an implementation detail, references to these objects are considered late bound (i.e., they are determined by looking through a lookup table or a global variable).

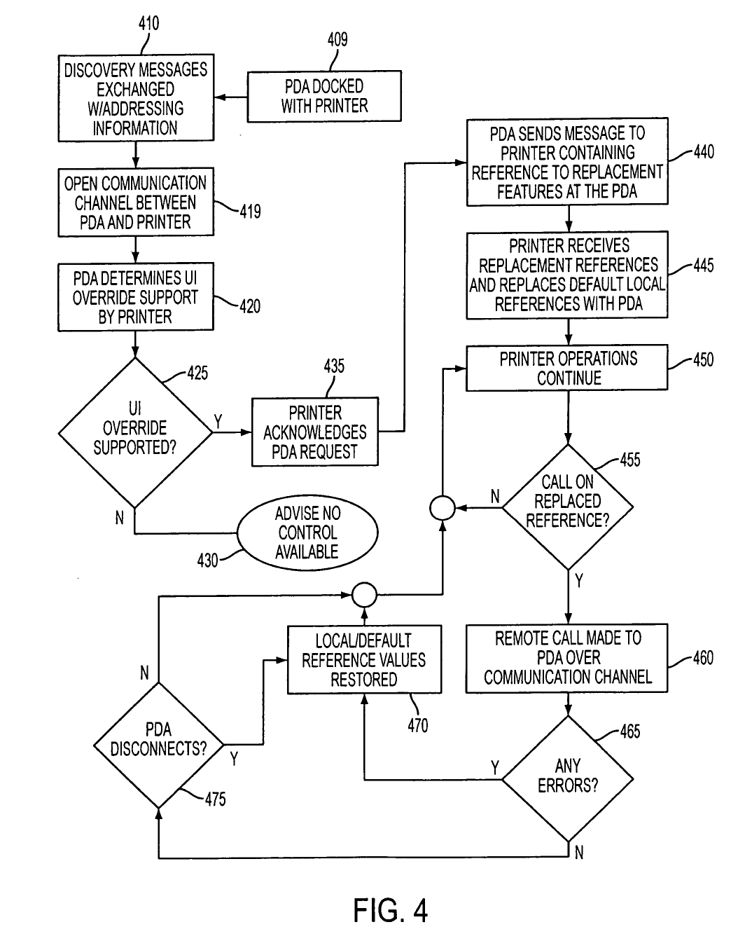

FIG. 4 illustrates an exemplary embodiment of a method of the present invention in which the portable computing device comprises PDA 100 and the printing device comprises printer 200. As illustrated in FIG. 4, at 405, a PDA may be physically docked with the printer so as to establish a communication path. It should be noted that according to other embodiments, PDA 100 may establish a communication path with printer 200 in a number of different manners. For instance, PDA 100 can wirelessly communicate with printer 200, or may be coupled through a USB port to printer 200 (i.e., not physically docked). Alternatively, PDA 100 may establish communication with printer 200 simply by approaching printer 200 (i.e., is within physical proximity).

In some embodiments, a discovery message may be sent between PDA 100 and printer 200 at 410 to establish communication between the devices. The message may notify each device about the existence of the other device (i.e. the printer may be notified about the existence of the PDA and the PDA may be notified about the existence of the printer). This discovery message may include sufficient addressing information to open a communication channel between the two devices at 415. The PDA may determine whether the printer supports overriding certain object references at 420 by sending a “query_interface” or “query_functionality” message to the printer for example.

The “query_interface” or “query_functionality” message may contain a globally unique identifier that ensures that the provider of the functionality (printer or PDA) and the client (PDA or printer) agree on the same named interface (and in some cases, on the same named implementation). PDA 100 may similarly request a particular version of functionality provided by printer 200. This unique identifier may be used to route the message to a piece (or, relevant portion) of the printer firmware capable of responding to the PDA's message; in the alternative, the unique identifier may be used to determine that the printer does not support the requested functionality.

If printer 200 does not support the requested functionality (i.e. overriding certain object references) as determined at step 425, a negative acknowledgement may be returned to PDA 100 or the PDA may not receive a response. The printer is assumed to not support the requested “override” capability and PDA 100 may be notified accordingly at 430.

If printer 200 does support the requested “override” capability, the printer response acknowledges the request by the PDA at 435. The PDA may then send a second message containing object references for PDA objects to printer 200 requesting that the printer override internal local references with the references supplied by the PDA at 440. The printer may save a copy of the original value(s) of the printer's references and replaces them with the references supplied by the PDA at 445. The second message from the PDA may be combined with the first discovery message from the PDA in some embodiments as an optimization.

As printer 200 may typically have multiple threads of control executing concurrently using the references, these global references or their lookup table may be controlled with a mutual exclusion mechanism. Multiple threads may, for example, include (i) receiving a job request from a computer or spooler; (ii) monitoring toner lever in the printer; and (iii) monitoring actuation of buttons on the user interface 240. This list is provided for exemplary purposes and is not intended to be an exhaustive list of threads executing on a printer. Using the mutual exclusion mechanism, the references may be safely updated and the locks (if any) may be released.

As printer 200 operates at 450 and a portion of printer firmware makes use of the overridden (i.e. new value) reference, the distributed object infrastructure in the printer will decode the reference. If printer 200 determines at 455 that the reference is not remote, printer operations continue at 450. If printer 200 determines at 455 that the reference is remote (on the PDA), printer 200 invokes a reverse remote procedure/remote object invocation to issue the call on the “docked” PDA at 460. Then, if no errors are detected as determined at 465 and if the PDA is still connected (i.e. docked) as determined at 475, the printer operations continue at 450. If any errors are encountered as determined at 465 or if the PDA is disconnected as determined at 475, the local or default reference values (i.e. of the printer) are restored at 470 and printer operation continues at 450. For example, if printer 200 encounters an error situation while PDA 110 has assumed control of the printer, the error that may typically be displayed to the user on printer display 210 may instead be displayed on PDA display 110.

The remote invocation may be received by the PDA and sent to the object corresponding to the remote reference and this object will update the local state on the PDA. While the mechanism is typically used for overriding remote user interface, it may also be used to remotely override any reference (i.e. any reference to which the printer has elected to provide the capability of being overridden). In an exemplary embodiment, a set of references may be updated simultaneously in a single message.

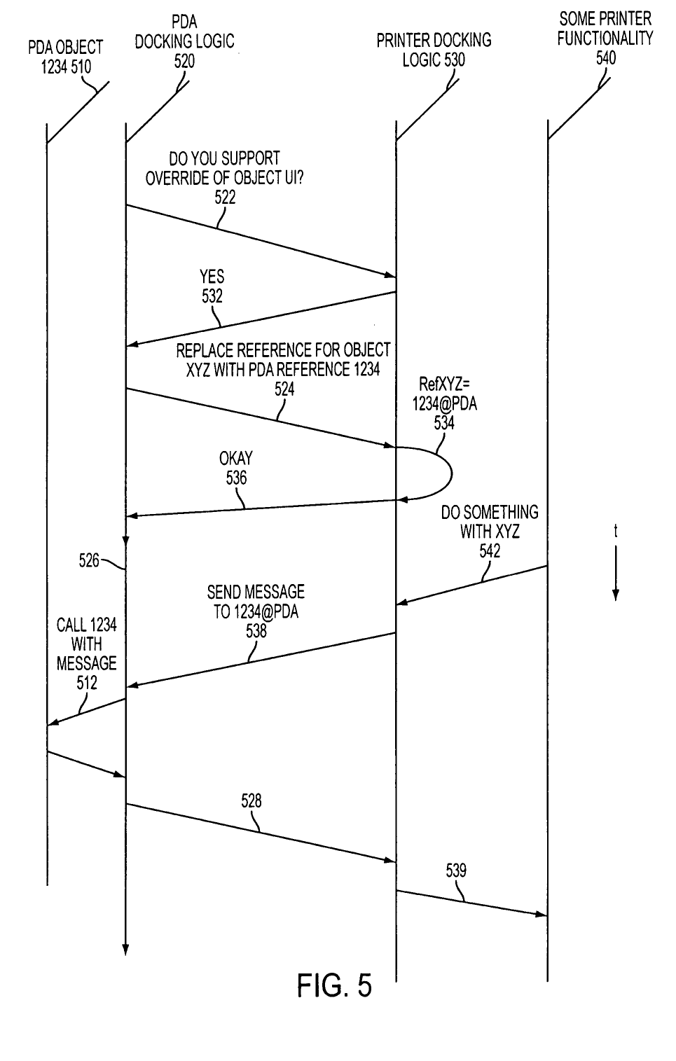

The replacement of printer values by PDA values may be illustrated with reference to the sequence diagram of FIG. 5. The activity of PDA 100 (represented by a PDA object “1234” 510 and PDA docking logic 520) and printer 200 (represented by printer docking logic 530 and printer functionality 540) after docking may be described as a function of time.

The printer docking logic 530 may be queried by PDA docking logic 520 at 522 whether override of the user interface is supported. If printer docking logic 530 responds in the affirmative at 532, PDA docking logic 520 may instruct printer docking logic 530 to replace a printer object (designated as RefXYZ in this case) by PDA object 1234 at 524. The printer docking logic 530 may at 534 replace RefXYZ with PDA object 1234 and submit a confirmation of the execution of the instruction to PDA docking logic 520 at 536. At this point in time, at least one printer object has been replaced a PDA object.

In the course of operation after docking, printer functionality 540 may process a request involving RefXYZ at 542. Since printer object RefXYZ has been replaced by PDA object 1234, printer docking logic 530 may send a message at 538 to object 1234 of PDA logic 520. PDA docking logic 520 may call object 1234 at 526. Object 1234 responds at 512 to PDA docking logic 520 which, at 528, forwards it to printer docking logic 530 that at 539, forwards to printer functionality 540.

If a wireless connection is used for “docking” PDA 100 with printer 200, the same wireless connection may be used for submitting jobs to PDA 100 on behalf of printer 200 or another connection may be used. If PDA 100 is physically docked with the printer, a second communication channel may be used when the PDA is “in front” of the printer (i.e. between computer 300 and printer 200, as shown in FIG. 3A).

If PDA 100 is piggy-backed on printer 200 (i.e. not between the computer and the printer but downstream from the printer, FIG. 3B), the PDA may override the control interfaces of the printer or may request that the printer redirect the entire print job to the PDA. In both cases, the same mechanism of overriding printer global references may be used and the distributed object infrastructure may be used to dispatch the incoming message to the PDA.

If PDA 100 is “in front” of printer 200 and is intended to receive the jobs before the printer, the PDA may register itself as the primary network address. This can be achieved by announcing a dynamic route message whereby the PDA becomes a router for the printer; the PDA can also register with a spooler indicating that the PDA is now acting on behalf of the printer. Such spoolers can be configured to redirect the print job to the PDA rather than going directly to the printer.

Authentication of PDA 100 may be performed to verify whether PDA 100 inserted in the print pipeline is authorized to control functionality of printer 200. Upon docking, PDA 100 may submit identification information to printer 200. Printer 200 may then compare this identification with pre-stored identification information. Based on the comparison, printer 200 may either accept or reject the connection with PDA 100. In some embodiments, printer identification information may also be pre-stored in PDA and this information may be used to authenticate printer 200 by PDA 100.

In some embodiments, an individual user's preferences may be stored in the user's PDA. A user may prefer printing contents of a document in landscape orientation with two inch margins using both sides of a page for example. The user's PDA may be connected to different printers at different times while retaining the user's specified preferences. As a result, the user need not re-specify preferences for each print job.

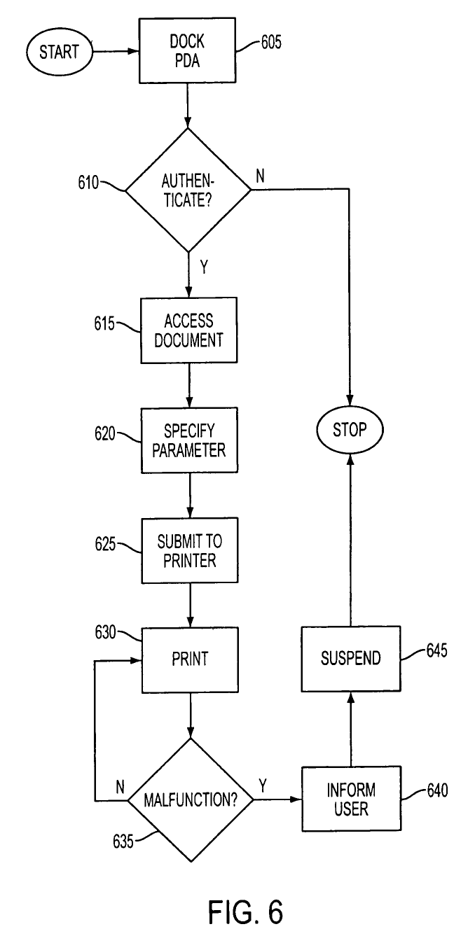

According to an exemplary embodiment in which a portable computing device (e.g., PDA 100) is used to control a printing device (e.g., printer 200), a print job may be controlled by a portable computing device as illustrated in FIG. 6. A PDA may be docked at 605 and the PDA may be authenticated at 610 as described above. If the PDA is not authenticated, the process may end.

If the PDA is authenticated, a document may be retrieved or received by the PDA at 615. The output parameters for the retrieved document may be specified by PDA 100 at 620. Output parameters may include, but are not limited to, number of copies, margins, which pages are printed, whether the print job is stapled, printed in duplex, or other job characteristics. In some embodiments, as described above, output parameters may be pre-stored in a PDA and correspond to the user's preferences. The document may be submitted to printer 200 at 625 and printing may take place at 630. The status of the printer may be monitored (or detected for malfunctions) at 635 while a print job is being executed.

A printer may malfunction due to low or dry ink (or toner) cartridge, paper jam and other service or mechanical conditions for example. If printer 200 does not encounter a malfunction at 635, the print job may continue. If a malfunction is detected at 635, the user may be informed of this condition at 640 via PDA 100 and the print job may be suspended 645. The user may then choose to save the unprinted portion of the print job or save the entire print job in PDA 100. The user specified parameters may also be saved with the print job.

PDA 100 may then be removed from the print pipeline and docked with another (a second) printer and the print job may be resumed or restarted at the second printer. The docking procedure described above in reference to FIG. 6 may be repeated with the second printer. In this manner, a print job may be “carried” from one printer to another printer. The user specified parameters need not be re-specified if the user preferences have been saved. It should be understood by one skilled in print system technology that some of the steps as illustrated in FIG. 6 may be optional. For instance, monitoring (or checking for malfunctions) at 635 may or may not be performed according to the embodiment shown in FIG. 6.

In some embodiments, a portable computing device (e.g., PDA 100) may be used as a security token. The reproduction (i.e. printing as a physical copy) of documents may be restricted to authorized users or authorized peripherals such as PDA 100. An authorized peripheral may be associated with an authorized user. A document may be located at a spooler (such as spooler 310 for example) and access to this document may be provided to an authorized PDA upon docking and authentication of the authorized PDA 100 with printer 200. Various levels of authorization may be granted to different users for example. PDA 100 may be authenticated and the user may retrieve, view and print a document but may not be able to annotate or manipulate contents of the retrieved document.

In exemplary embodiments, a portable computing device may also control a printing device to alter the prioritization of print jobs in a print spooler. Referring to FIG. 7A, a number of print jobs 710 may be placed in a print queue. Each print job may have a corresponding timestamp 730 that reflects the time at which the print job was generated for example. Each print job may also have a corresponding file size 720. The items on the queue may typically be processed based on the timestamp. In the illustrated example, the order of printing may be 1, 2, 3 and 4.

The order of the print jobs may be changed via the portable computing device to print based on the size of the file for example. Smaller jobs may be processed before larger jobs or vice versa. The portable computing device may either receive all jobs and store them locally or may interact with a remote spooler and re-order the jobs at the spooler. In the illustrated example, the order of printing may be changed to 4, 2, 1 and 3 as illustrated in FIG. 7B.

Exemplary embodiments may provide these features at the printing device location or within close proximity of the printing device due to the physical location of the portable computing device near the printing device. The portable computing device may also interact with spooler 310 (FIG. 3A) to adjust the priority, etc. In order to control the spooler, the portable computing device may send a message to the spooler to “pause the print queue”. The spooler may then suspend (or pause) all jobs in the queue that are not “selected” and then “release the print queue”. The released print job would then be printed. Alternatively, some spoolers support the notion of a priority on print jobs and the portable computing device may send a message to the spooler changing the priority of jobs based on the user or device preferences. Other preferences may include, for example, printing larger jobs first or those originating from a particular source before other pending jobs, etc.

Since the portable computing device serves as a user interface to the printing device, the portable computing device may enable a manipulation of print jobs; in addition, the functionality of the printing device may be enhanced or augmented by the portable computing device. Print jobs may be previewed on the display area of the portable computing device. The user interface (such as keyboard, writing area or microphone) of the portable computing device may be used to insert text, notes or voice annotations into contents of a document for example. This takes place after a document has been created at the non-portable computing device but prior to the document being printed by the printing device.

In some embodiments, the portable computing device may supplement contents of documents using the scanning function of a printing device having scanning capability. An audio portion may supplement contents of a document for example. A scanned image may be annotated with an audio clip such as a voice. An audio clip such as “I want to you to look at page 3” may be embedded into a particular portion of a document for example and saved as a .pdf file. The voice recognition capability using the microphone of the portable computing device may be used for this purpose. The command may also be incorporated as a .wav file. In this manner, the portable computing device augments the scan capability of the printing device allowing the scanned image to be sent via e-mail with a MIME attachment that includes the voice annotations. The contents of the document with the annotation may be e-mailed to a recipient. The recipient may then click on the embedded .wav file, for example, to hear the audio clip.

By assuming control of the printing device, the portable computing device may also incorporate I/O ports (e.g., I/O ports 295) of the printing device into the portable computing device. In this way, if a memory stick or a flash card is inserted into the I/O ports of the printing device, the contents of such media may be retrieved, viewed and manipulated or supplemented by the portable computing device.

Portable computing devices such as PDAs and cell phones often include contact information. In some embodiments, document contents (such as a print job from the non-portable computing device that is accessed by the portable computing device) may be submitted to recipient(s) selected from the contact information. A user may wish to send a document by fax or to an e-mail address. A user's personal contact list may not be available at the non-portable computing device but may be available in the portable computing device. The fax number or e-mail address for the selected recipient may be retrieved from the portable computing device and a document sent in the selected manner (i.e. fax or e-mail). The portable computing device may send the e-mail if the portable computing device is “in front” of the printing device (e.g., between a computer and a printer); alternatively, if the portable computing device is downstream from the printing device, the printing device may send the e-mail based on e-mail address supplied by the portable computing device.

The foregoing description of exemplary embodiments of the present invention provides illustration and description, but it is not intended to be exhaustive or to limit the invention to the precise form disclosed. Modifications and variations are possible in light of the above teachings or may be acquired from practice of the invention. For example, printing devices may in the future include video capability such as being able to project contents of a file. As with audio annotation described above with reference to inserting audio clips, video clips may also be inserted into documents and the inserted video clips may be projected. In may be utilized to enhance the functionality of other basic devices, appliances, etc.

The following claims and their equivalents define the scope of the invention.

1. A system comprising:
a non-portable computing device;
a printing device connected to the non-portable computing device; and
a portable computing device intermediate the non-portable computing device and the printing device,
wherein when a communication path is established between the portable computing device and the printing device, the portable computing device assumes a control of operation of the printing device.

2. The system of claim 1 wherein the non-portable computing device is one of a desktop computer and a docked laptop computer.

3. The system of claim 1 wherein the printing device comprises at least one of a multi-function peripheral, an All-In-One device, and a single function printer.

4. The system of claim 1 wherein the portable computing device is at least one of a personal digital assistant (PDA) and a cellular phone.

5. The system of claim 4 wherein the PDA comprises a user interface for providing control of operation of the printing device to a user.

6. The system of claim 1 wherein a type of communication path established between the portable computing device and the printing device is dependent on a physical proximity of the portable computing device to the printing device.

7. The system of claim 1 wherein the portable computing device is docked with the printing device via USB ports of the respective devices to establish the communication path.

8. The system of claim 1 wherein the communication path is established via a wireless interface.

9. The system of claim 1, further comprises a spooler intermediate the non-portable computing device and the portable computing device wherein the portable computing device interacts with the spooler.

10. The system of claim 1, further comprising at least a second printing device connected to the network wherein the second printing device provides replacement functionality based on an inoperability of the printing device and the second printing device is controlled by the portable computing device.

11. A method for controlling functionality of a printing device connected to a network having at least one non-portable computing device, the method comprising the steps of:
establishing a communication path between a portable computing device and the printing device over said network, the portable computing device being located intermediate the non-portable computing device and the printing device; and
assuming a control over operation of the printing device by the portable computing device wherein the portable computing device:
receives output instructions for contents of a file, intended for the printing device, from the non-portable computing device;
provides a user interaction via a user interface; and
executes the instructions via the printing device.

12. The method of claim 11 wherein the portable computing device is at least one of a personal digital assistant (PDA) and a cellular phone.

13. The system of claim 11 wherein the printing device comprises at least one of a multi-function peripheral, an All-In-One device, and a single function printer.

14. The method of claim 11, further comprising:
disabling an user interface of the printing device; and
enabling an user interface of the portable computing device.

15. The method of claim 11, further comprising:
enabling an user interface of the portable computing device.

16. The method of claim 11 wherein the control assumed by the portable computing device includes incorporating input/output (I/O) ports of the printing device by the portable computing device.

17. The method of claim 11, further comprising:
previewing contents of the file by the portable computing device.

18. The method of claim 11, further comprising:
modifying the instructions received from the non-portable computing device by the portable computing device.

19. The method of claim 18 wherein the modifying comprises specifying output parameters.

20. The method of claim 19 wherein the parameters comprise at least one of duplex printing, printing a plurality of logical pages per one physical page and specifying an orientation.

21. A method of processing an output request from a non-portable computing device connected to a printing device, the method comprising:
connecting a portable computing device intermediate the non-portable computing device and the printing device;
assuming a control over operation of the printing device by the portable computing device;
authenticating the portable computing device;
receiving, by the portable computing device, data from the non-portable computing device;
applying a set of user preferences to the data;
submitting the data with the user preferences to the printing device; and
outputting the data with the user preferences by the printing device.

22. The method of claim 21 wherein the authentication determines an ability of a user to manipulate the received data.

23. The method of claim 21 wherein the data from the non-portable computing device is received by the portable computing device via a spooler.

24. The method of claim 23 wherein the control that is assumed over the printing device includes manipulating output jobs residing on the spooler.

25. The method of claim 24 wherein the manipulation includes re-ordering the output jobs.

26. The method of claim 25 wherein the re-ordering is based on a size of the output jobs.

27. The method of claim 21 further comprising:
pre-storing the user preferences in the portable computing device.

28. The method of claim 21 further comprising:
specifying the user preferences by a user upon receipt of the data by the portable computing device.

29. The method of claim 28 further comprising:
specifying the user preferences by the user via a user interface of the portable computing device.

30. The method of claim 21 wherein the user preferences comprise annotation of data received by the non-portable computing device from the user.

31. The method of claim 30 wherein the annotation includes inserting audio clips within the data.

32. The method of claim 30 wherein the annotation includes inserting video clips within the document.

33. The method of claim 21 further comprising:
monitoring an operational status of the printing device, by the portable computing device, for malfunctions.

34. The method of claim 33 wherein the malfunctions includes at least one of a paper jam, a dry toner cartridge and a service due date.

35. The method of claim 33 further comprising:
notifying a user of a malfunction via the user interface of the portable computing device.

36. The method of claim 35 further comprising:
suspending, by the portable computing device, submission of the data with the user preferences to the printing device;
saving user preferences in the portable computing device;
disconnecting the portable computing device;
connecting the portable computing device to a second printing device;
authenticating the portable computing device with the second printing device; and
resuming outputting of the data on the second printing device.
